(19) United States
(12) Patent Application Publication
(10) Pub. No.: US 2011/0264333 A1
(43) Pub. Date: Oct. 27, 2011

(54) Vehicle glare reducing systems

(76) Inventor: Seymour C. Yuter, Briarcliff Manor, NY (US)

(21) Appl. No.: 13/135,307

(22) Filed: Jun. 30, 2011

Related U.S. Application Data
(63) Continuation of application No. 12/655,446, filed on Dec. 30, 2009.
Application No. 12/655,446 is a continuation-in-part of application No. 11/890,409, filed on Aug. 6, 2007, now Pat. No. 7,669,636.

(51) Int. Cl. B60J 3/00; G06F 7/00; B60J 3/02

(52) U.S. Cl. 701/49; 296/97.1; 296/97.4; 701/36

(57) ABSTRACT

A vehicle glare reducing system comprising automatically optically detecting when an oncoming vehicle with lit headlights is approaching the driver and automatically operating a glare reducing means attached to the driver's side of a vehicle's windshield to block the glare, and automatically optically detecting when no oncoming vehicle with lit headlights is approaching the driver and automatically operating the glare reducing means to allow the driver to see through the glare reducing means, with part of an inside edge of the glare reducing means substantially vertically aligned with substantially the horizontal center of the vehicle's steering wheel.

This application is a continuation of continuation-in-part application Ser. No. 12/655,446 filed Dec. 30, 2007, for Vehicle Glare Blocking Systems, which is a continuation-in-part of application Ser. No. 11/890,409 filed Aug. 6, 2007, for Glare Blocking Vehicle Attachment (“parent application”) issued Mar. 2, 2010, as U.S. Pat. No. 7,669,636.

### BACKGROUND OF THE INVENTION

1. Field of the Invention

This invention pertains to safety systems for vehicles and more particularly to vehicle glare blocking systems to block the beams of headlights of oncoming vehicles to prevent dangerous and even blinding glare, especially in the eyes of older drivers, mainly on two lane roads and particularly when it is raining.

2. Background of the Invention

Driving requires effective coordination of visual, motor and cognitive skills. Visual skills are pushed to their limit at night by decreased illumination and by disabling glare from oncoming headlights. Glare is proportional to headlight brightness so increasing headlight brightness also increases glare for oncoming drivers, especially on two lane roads and particularly in the rain. This problem is worse for older drivers because of their increased intraocular light scattering, glare sensitivity and photostress recover time.

Modern vehicle headlights are electrically operated, positioned in pairs, one or two on each side of the front of a vehicle. A headlight system produces a low and a high beam. High beams are used when other vehicles are not present on the oncoming side of the road. Low beams have stricter control of upward light, and direct most of their light downward and either rightward (in right-traffic countries) or leftward (in left-traffic countries) to provide safe forward visibility without excessive glare.

A night driving problem, especially for older drivers on two lane roads, and particularly when it is raining, is that oncoming high beams can be blinding, and even oncoming low beams can cause dangerous glare. That is because, with increasing age, cataracts in the eye's lens scatter the oncoming light.

A cataract is the clouding of the normally transparent lens within the eye. The lens is located directly behind the pupil and normally assists in focusing light for clear vision. As the cataract worsens it prevents light from coming through the pupil and focusing clearly on the retina. Early changes may be very minor, but as the process continues symptoms of blurred vision, light sensitivity, glare and night driving difficulties increase. The nighttime driving difficulties are mainly caused by headlight glare. It takes a typical driver ten seconds to recover from headlight glare and this time increases with age. At 30 miles an hour a car travels an eighth of a mile in 10 seconds.

This nighttime driving problem has intensified with vision-disabling nighttime glare from three types of headlights mounted on the front of motor vehicles: “high intensity discharge” (HID) lights that appear blue, auxiliary lights such as “fog lamps”, and headlights mounted high on various light trucks (sport utility vehicles, pickups and vans).

According to a U.S. Department of Transportation Technical Report (DOT HS 809 669 October 2003), 31% of drivers are disturbed by headlight glare and 1% had a crash or near miss. And, surprisingly, many more 35-54 drivers are disturbed by headlight glare than older drivers. Finally, nighttime driving difficulties from headlights and glare are exacerbated in the rain and especially heavy rain to the point that a driver can be blinded.

### BRIEF SUMMARY OF THE INVENTION

A general object of the invention is to improve the safety of nighttime drivers.

Another object of the invention is to improve the safety of older drivers, especially when driving on two lane roads and particularly in the rain.

A further object of the invention is to provide an improved attachment for a vehicle and an improved method of using the attachment which blocks headlight beams from oncoming vehicles to prevent dangerous glare in the eyes of nighttime drivers.

A specific object of the invention is to provide a vehicle glare blocking system which automatically blocks headlight beams from oncoming vehicles to prevent dangerous glare in the eyes of nighttime drivers.

Briefly, in accordance with the embodiment of the invention as disclosed and claimed in the parent application, a method of reducing glare from oncoming vehicle headlights is provided comprising providing an attachment for a vehicle having a front windshield, a driver's side and a passenger side, the attachment comprising a slatted blind having a plurality of horizontally-oriented slats extending between a headrail and a bottom rail, a flexible cord ladder connected between the headrail and bottom rail and supporting the slats, and a rotation means for rotation of the slats from opened to closed. Securing the slatted blind with mounting means connecting the headrail to an upper portion of the inside of the vehicle's front windshield on the driver's side such that the attachment has a width less than 30 percent of the horizontal width of the vehicle's front windshield and the passenger side is uncovered. Driving the vehicle on a surface that can have oncoming traffic. Rotating the rotation means to operate the slats such that they are open and allow a driver to see through the slats when there is no oncoming traffic with lit headlights approaching. Rotating the rotation means while driving to operate the slats such that they are closed and prevent a driver from seeing through the slats when there is at least one oncoming vehicle with lit headlights approaching the driver. And repeating the rotating steps while driving to accommodate varying oncoming traffic.

A feature of the invention claimed in the parent application is detachably connecting the inside lower corner of the window blind to the horizontal surface of the vehicle's dashboard to help maintain the window blind vertical while the vehicle is in motion.

Another feature of the invention claimed in the parent application is bending an incline wire that passes through an opening in the lower left end of the window blind about ninety degrees toward the windshield to maintain the lower end of the window blind in an horizontal position and help maintain the window blind vertical, with the incline wire connected to a window-mounted suction cup loosely rather than tightly as required for inclined window installations in housing structures.

A further feature of the invention claimed in the parent application is slat rotation means comprising a turning rod positioned so its outer end is adjacent to the steering wheel so it can be turned with a thumb and one or two adjacent fingers while the remaining fingers grasp the steering wheel for safer driving.

A still further feature of the invention claimed in the parent application is a suction cup attached to the upper left portion of the windshield to retain the window blind's lift cords out of the driver's road view path for safer driving.

An advantage of the invention claimed in the parent application is that the basic window blind, which is readily modified in accordance with the invention, is commercially available at a reasonable cost from a window blind manufacturer.

Briefly, in accordance with the preferred embodiment of invention as first disclosed and claimed in this application, a vehicle glare blocking system automatically optically detects when an oncoming vehicle with lit headlights is approaching the driver and automatically operates an electric motor to close the slats of a window blind attached to the driver's side of a vehicle's windshield to block the glare, and automatically optically detecting when no oncoming vehicle with lit headlights is approaching the driver and automatically operating the electric motor to open the slats to allow the driver to see through the slats of the window blind.

A feature of the invention first disclosed and claimed in this application is mounting means connected to the automatic optically detecting apparatus for mounting the automatic optically detecting apparatus on the inside of the windshield adjacent the rearview mirror.

Another feature of the invention first disclosed and claimed in this application is the central portion of the slats of the window blind are opaque and the remaining slats of the window blind are transparent to minimize the blocked portion of the windshield when the slats are closed.

Alternative embodiments of the invention first disclosed and claimed in this application include a manual switch-operated electric motor and, alternatively, a wireless operated electric motor in place of the automatic optical detection apparatus to open and close the slats of the window blind. The switch or the wireless transmitter manually can operate the electric motor to open closed slats when needed, especially for left turns, even with the automatic optical detection apparatus.

An advantage of the invention first disclosed and claimed in this application is that the automatic optical detection apparatus is commercially available to dim a driver's headlight high beams when an oncoming vehicle with on headlights is detected.

Another advantage of the invention first disclosed and claimed in this application is that the embodiments can be installed in existing vehicles as attachments, or built into new vehicles as original equipment.

The invention claimed in this application in a nutshell is to use a slatted blind designed for home skylights to reduce headlight glare while driving plus an optical detecting means originally designed to dim headlights of the driver's vehicle instead to automatically block glare from an oncoming vehicle.

2. Description of Related Art

Venetian window blinds are used not only for windows of housing structures but also across the full width of rear and side vehicle windows to protect the vehicle and its passengers from direct sunlight. The rays of the sun can damage the interiors of most vehicles over time. Window blinds also block the sun from heating the interior of a vehicle. Usually, these window blinds are pulled up for nighttime driving so as not to block vision through the windows. An example of such blinds is disclosed in U.S. Pat. No. 2,234,804 to Julian W. Murray and U.S. Pat. No. 5,570,734 to Hans Wu, both cited in the prosecution of the parent application.

Another device for blocking sunlight through a front windshield is an accordion-folded retractable sun shade which is adhered to the sloping windshield pillar on the passenger's side of a vehicle and can be drawn over the full length of the windshield during the day, and is fully retracted for driving.

There is also a retractable visor with tinted slats positioned over all of the upper half of a vehicle's front windshield to protect from dangerous sun glare. However, the lower half of the windshield is not blocked so if used at night the visor would not block oncoming headlight glare.

The window blind of the invention, totally opposite to these teachings, when activated to block oncoming headlight glare, only blocks part of the driver's side of a vehicle's front windshield and thus the view of the oncoming traffic lane, so the driver can always see all of the vehicle's lane, and is used only at nighttime to block glaring and blinding headlight beams of oncoming vehicles in the oncoming lane, especially on two lane roads and in the rain.

A high-beam headlight control system is disclosed in detail in U.S. Pat. No. 5,537,003 (003 patent) for a Control System for Automotive Vehicle Headlamps and Other Vehicle Equipment issued Jul. 16, 1996, to Gentex Corporation of Zeeland, Mich. This system operates automatically to switch the headlights from high beam to low beam when an oncoming vehicle with headlight glare is detected. And it operates to switch the headlights from low beam to high beam when an oncoming vehicle with headlight glare is not detected. There is no remote suggestion in the 003 patent for opening and closing slats of a window blind as claimed in this application.

Most importantly, there is no suggestion of this invention in the 110-page publication prepared for The AAA Foundation for Traffic Safety, Washington, D.C., in December 2001, entitled “Countermeasures for Reducing the Effects of Headlight Glare.” This AAA publication also reports that as many as 50 percent of all headlights on the road may be misaimed, further aggravating the problem of headlight glare.

### BRIEF DESCRIPTION OF THE DRAWINGS

Other objects, features and advantages of the invention will be apparent from the following description taken together with the accompanying drawings in which:

FIG. 1 (also in the parent application) is a front elevational view taken from the driver's seat of a vehicle showing a glare blocking vehicle attachment in accordance with the embodiment of the invention claimed in the parent application in which the window blind covers less than the left third area of the vehicle's front windshield, with suction cups connecting the upper corners of the window blind to the inside surface of the vehicle's windshield, and with the window blind's slats closed manually by a turning rod and gear box to block oncoming headlight glare. Also shown is a suction cup-hook connected to the upper left portion of the windshield for retaining the window blind lift cords out of the driver's viewing path.

FIG. 2 (also in the parent application) is a side perspective view of the glare blocking vehicle attachment of FIG. 1 showing the turning rod, which has opened the slats of the window blind, hanging from a corner of the window blind with its external tip adjacent the steering wheel so the driver can rotate the turning rod with two or three fingers of one hand to open and close the slats while the remaining fingers hold the steering wheel; and also showing the inside lower corner of the window blind detachably attached to the horizontal surface of the vehicle's dashboard to help maintain the window blind substantially vertical when the vehicle is in motion.

FIG. 3 (also in the parent application) is a front elevational view of the glare blocking windshield attachment of FIGS. 1 and 2 with the slats of the window blind pulled up and out of the way for daylight driving, and showing slack incline wires of the window blind connected to suction cups-hooks attached to the lower inside of the windshield to help maintain the window blind substantially vertical during vehicle movement. When the window blind slats are down, the left incline wire also supports the lower left corner of the window blind in the space above the left-declining horizontal surface of the vehicle's dashboard so that its bottom rail is substantially horizontal to facilitate easy rotation of the slats from the open to the close position.

FIG. 4 (new in this application) is a front elevational view of an improved glare blocking attachment of FIG. 1 with an electric motor and gearhead, in place of the manual turning rod and gear box, to open and close the slats, manually operated by an open-close switch hanging adjacent the steering wheel or, alternatively, automatically operated by a high-beam headlight control system (FIG. 5), and with only the central opaque portion of the window blind slats blocking oncoming headlight glare. Also shown in dotted outline on the steering wheel is a wireless transmitter for operating a wireless operated slat rotation device shown in FIG. 4B.

FIG. 4A (new in this application) is a front elevational view taken through the headrail of the glare blocking attachment of FIG. 4 showing a limit switch assemblage comprising two limit switches which limit rotation of the electric motor shaft clockwise and counter clockwise about ninety degrees to close and open the slats.

FIG. 4B (new in this application) is a front elevational view of the upper left corner of the glare blocking vehicle attachment of FIG. 1 improved with the wireless operated slat rotation device to open and close the slats under control of the wireless transmitter shown in dotted outline in FIG. 4.

FIG. 5 (new in this application) is a simplified pictorial diagram viewed through a vehicle windshield which depicts the major components of the automatic high-beam headlight control system that works in combination with a slats open-close circuit (FIG. 6) automatically to block glare from oncoming vehicle headlights. Shown in dotted outline is a wireless transmitter for automatically operating the wireless operated slat rotation device shown in FIG. 4B.

FIG. 6 (new in this application) is a schematic circuit diagram of the slats open-close circuit which works with the high-beam headlight control system of FIG. 5 to automatically block glare from oncoming vehicle headlights.

FIG. 6A (new in this application) is a schematic circuit diagram of the open-close switch hanging adjacent the steering wheel in FIG. 4 which works in place of the high-beam headlight control system input of FIG. 6 to manually close the slots to block glare from oncoming vehicle headlights or to open the slats when there is no oncoming glare or for left turns.

### DESCRIPTION OF PREFERRED EMBODIMENT OF THE INVENTION IN PARENT APPLICATION

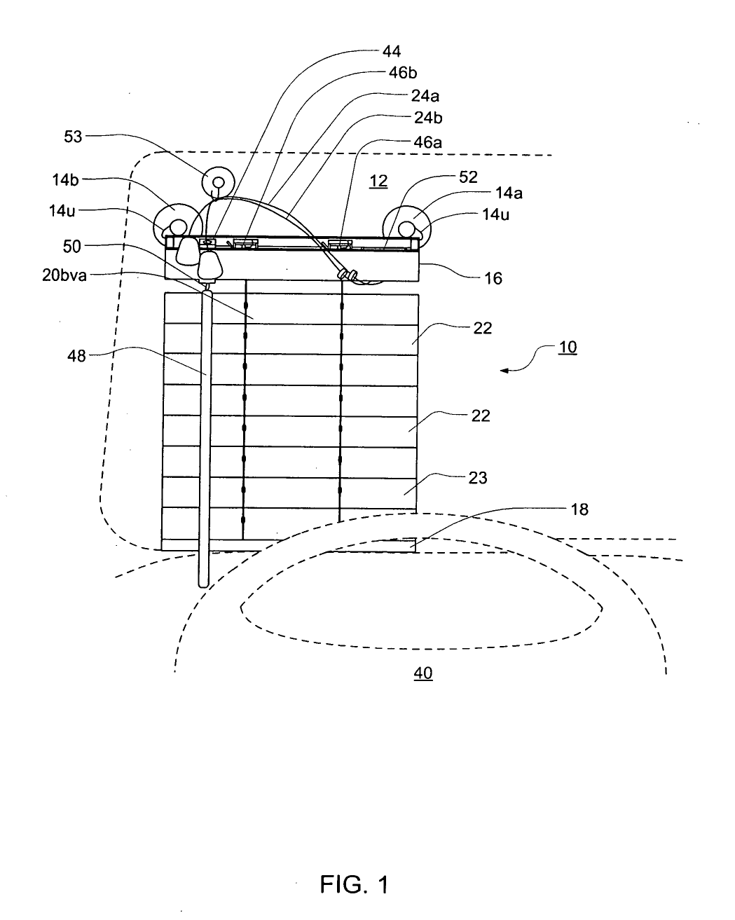

In accordance with the preferred glare blocking vehicle attachment invention in the parent application, window blind 10 (FIG. 1) is attached to the upper inside surface of the vehicle's front windshield 12 by a pair of suction cup connectors 14a and 14b, each 2.5 inches in diameter.

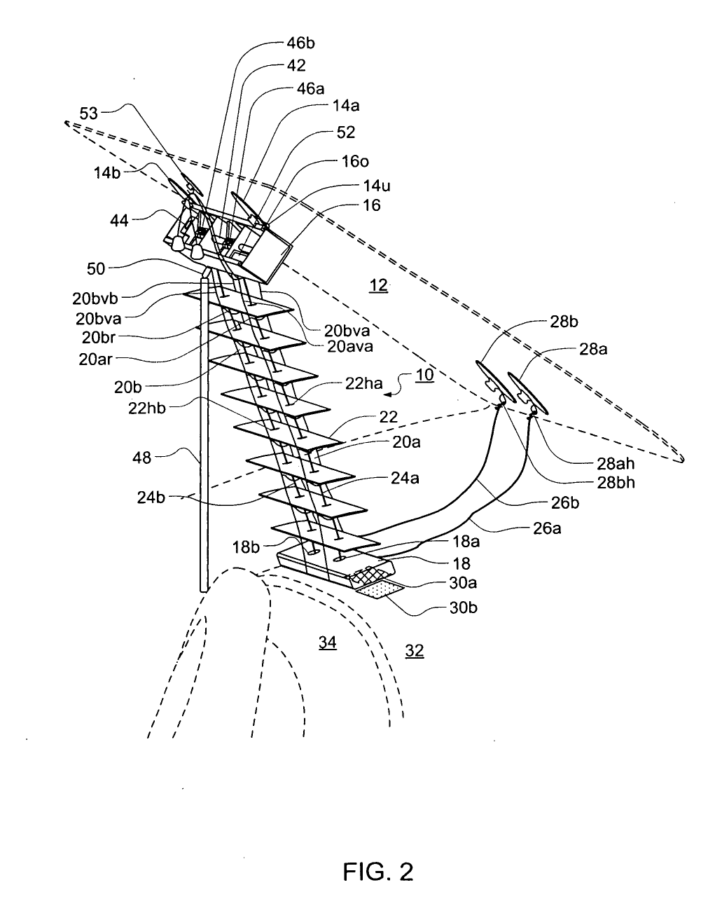

Window blind 10 (FIG. 2) comprises the headrail 16, the bottom rail 18 and the flexible cord ladders 20a and 20b connected between the headrail 16 and the bottom rail 18. Each suction cup connector 14a and 14b has its hook bent into a shallow U, 14u (FIG. 1), with its free end inserted into an opening 16o (FIG. 2) at the upper inside corner edge of headrail 16 nearest windshield 12 to mount the headrail 16 via each suction cup connector 14 to the inside surface of windshield 12 by suction.

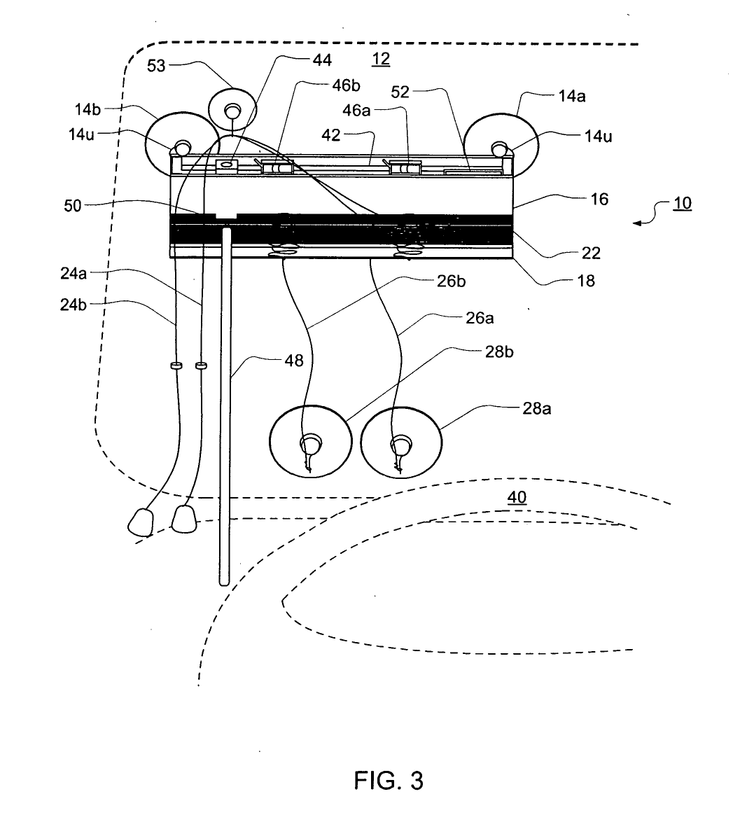

Each of the cord ladders 20a and 20b (FIG. 2) comprises a pair of parallel vertical cords respectively 20ava and 20avb and 20bva and 20bvb connected respectively by spaced ladder rungs 20ar and 20br. Each of a plurality of slats 22 is loosely supported in matching ladder rungs 20ar and 20br of the cord ladder 20. Each of the slats 22 has a shallow oval hole 22ha and 22hb respectively near each outer end. Lift cords 24a and 24b are connected between the headrail 16 and the bottom rail 18 respectively through the holes 22ha and 22hb. The bottom ends of lift cords 24 are fixedly connected to bottom rail 16 so that when the lift cords 24 are pulled up, they pull the bottom rail 16 up compressing slats 22 together as shown in FIG. 3.

Flexible steel incline wires 26a and 26b (FIG. 2) are connected to headrail 16 and parallel the lift cords 24a and 24b through holes 22ha and 22hb. They pass through openings 18a and 18b respectively in bottom rail 18 and bend about ninety degrees toward the windshield 12. Then steel incline wires 26a and 26b respectively connect to lower suction cup-hooks 28ah and 28bh which are suction connected to the lower edge of windshield 12 below suction cup connectors 14a and 14b. Suction cup-hooks 28a and 28b are also each 2.5 inches in diameter. The portions of the flexible steel incline wires 26a and 26b between the bottom rail 18 and suction cup-hooks 28ah and 28bh are slack to allow the window blind 10 to hang vertically downward rather than along the inside surface of windshield 12 if the steel incline wires 26 were pulled tight (as in conventional inclined window house installations). The bottom ends of the steel incline wires 26a and 26b respectively pass through the pinched hook portions of the suction cup-hooks 28ah and 28bh, then double back and are twisted together to make the connections. This arrangement allows the lengths of the steel incline wires 26a and 26b to be adjusted during installation of the window blind 10 so that the bottom rail 18 hangs vertically downward. When the window blind 10 is vertical there is maximum spacing between the slats 22 to allow for unobstructed vision through slats 22 when they are in open (horizontal) position.

The right bottom end of bottom rail 18 (FIG. 2) has an adhered female VELCRO strip 30a which is detachable connectible to the matching male VELCRO strip 30b adhered to the top surface of the upper horizontal portion 32 of the dash panel 34 to anchor the right bottom end so that the bottom rail 18 does not move during vehicle movement and the window blind 10 is substantially vertical. However, the upper horizontal portion 32 descends downwardly on its left side so that the left end of the bottom rail 18 is supported only by the steel incline wire 26b. Thus the bottom rail 18 is essentially fixed in a substantially horizontal position and the window blind 10 is vertical and does not move with vehicle movement. For daylight driving the bottom rail 18 is detached from the VELCRO strip 30b and raised together with the slats 22 as shown in FIG. 3.

The right edge of the window blind 10 (FIG. 1) is vertically aligned with the vertically central third portion of the steering wheel 40. Preferably the right edge of window blind 10 is vertically aligned with a vertical line through the center of steering wheel 40 as shown in FIG. 1.

Headrail 16 (FIG. 3) comprises a centrally aligned hexagonal turn axle 42 which passes through a matching center hexagonal opening of gear box 44 and also matching center hexagonal openings of ladder cord drums 46a and 46b. Rod 48 is connected to gear box 44 via a rotatable loop-shaped link 50 (FIG. 1). The vertical ladder cords 20ava and 20avb (FIG. 2) are connected to ladder cord drum 46a, and the vertical ladder cords 20bva and 20bvb are connected to ladder cord drum 46b. When the window blind 10 is in the open position the ladder cord rungs 20ar and 20br are horizontal so the slats 22 are horizontal. That is because the ladder cord drums 46a and 46b are in a rotate position so that the vertical ladder cords 20ava and 20avb are of equal length as are the vertical ladder cords 20bva and 20bvb. In that position of the window blind 10 there is maximum vision between slats 22 because they are horizontal.

To close window blind 10 with slats 22 in a substantially vertical position as shown in FIG. 1, the rod 48 (FIG. 2) is turned counter clockwise, which operates the gear box 44 to rotate turn axle 42 clockwise so that the ladder cord drums 46a and 46b rotate clockwise pulling the vertical ladder cords 20avb and 20bvb up so that the ladder cord rungs 20ar and 20br are moved to a substantially vertical position rotating slats 22 to a substantially vertical position and closing the window blind 10, blocking any vision through window blind 10. To open window blind 10 rod 48 is turned clockwise, which operates the gear box 44 to rotate turn axle 42 counter clockwise so that the ladder cord drums 46a and 46b rotate counter clockwise pulling the vertical ladder cords 20ava and 20bva upwards so that the ladder cord rungs 20ar and 20br are moved to an horizontal position rotating slats 22 to the horizontal position and opening window blind 10.

Thus the window blind 10 can be open when there is no oncoming vehicle headlight glare and closed when there is oncoming vehicle headlight glare, to avoid temporarily blinding the driver.

The window blind 10 (FIG. 1) is mounted on the inside surface of the windshield 12 so that the external tip of rod 48 is adjacent the left side of the steering wheel 40 so the driver can rotate the rod 48 with two or three fingers of the left hand to open and close the slats 22 while the remaining fingers hold the steering wheel 40 to increase driving safety.

Headrail 16 (FIG. 2) at its inner right end has a lift cord control 52 through which the lift cords 24a and 24b pass. When the lift cords 24 are pulled to the left, lift cord control 52 allows slats 22 together with bottom rail 18 to be moved up and down. When the lift cords 24 are pulled to the right, lift cord control 52 grasps the lift cords 24 so that they are fixed at their then positions. So the slats 22 of window blind 10 can be raised vertically by lift cords 24 to retract and compress the slats 22 together and thus compress the window blind 10 in a raised position for daylight driving as shown in FIG. 3. A suction cup-hook 53 is attached to the upper left portion of the windshield 12 for retaining the window blind lift cords 24 out of the driver's vision path when window blind 10 is retracted for daylight driving or in its lowered position for nighttime driving. Suction cup-hook 53 is one and a quarter inch in diameter.

In night operation the window blind 10 is normally in the open position (FIG. 2). When oncoming vehicle headlights are in the distance, the window blind is closed by rod 48 (FIG. 1) to block the headlight glare from the oncoming vehicle. The driver can view the driver's side of the road through the unblocked windshield 12 to the right of the window blind 10. Moreover, when desired, the driver can move his or her torso to the right to see more of the left side of the road, and still more by tilting the head to the right. Also, for left turns, the window blind 10 must be open (FIG. 2) to see the right (driver's) side of the road.

In the vehicle headlight glare blocking attachment as reduced to practice, slatted window blind 10 is a commercial window blind manufactured by Springs Window Fashions of Middleton, Wis. Its construction and operation are well known in the window blind art, though discussed in some detail herein. The commercial window blind has the following specification under the title “Bali Classics 8GA”: “Horiz Tension Wire, WIDTH-9, HEIGHT-14, 7205-White Satin, O-Outside Mount, L-Left Tilt, R-Right Lift, W-Wand Tilt, 6″ Wand, 215-Ladder Spacing 21.5 mm.” The retail cost of the commercial window blind is around $30. There is no need for the mounting brackets provided to mount the window blind in a window. Instead, suction cups are used to mount the window blind on the inside surface of the vehicle's front windshield as disclosed herein. Also, the slope of the front windshield is around 45 degrees with respect to the horizontal while the window blind 10 is substantially vertical, or 90 degrees.

In the preferred embodiment of the invention as claimed in the parent application, there are two modifications of this commercial window blind. One is the addition at the lower right surface of the bottom rail 18 of the VELCRO attachment 30 to detachably connect the right end of the bottom rail 18 (FIG. 2) to the upper horizontal surface 32 of the vehicle's dash board 34. The other modification is to change the gear ratio of the gear box 44 so that a single 360 degree rotation clockwise of the rod 48 opens window blind 10 and a single 360 degree rotation counter clockwise closes window blind 10. In the commercial window blind's gear box multiple turns are needed to both open and close the window blind.

In the vehicle headlight glare blocking attachment as first reduced to practice the slatted window blind 10 is nine inches wide. The width of the vehicle's front windshield varies from 65 inches at its widest to 49 inches at its top. The windshield width along its vertical center in line with the top of the steering wheel is 55 inches. So the percentage of the width of the window blind to the width of the windshield is, respectively, 14 percent (at its widest), 18 percent (at the top) and 16 percent (at the vertical center). Correspondingly, the unblocked portion of the windshield to the right of the window blind is, respectively, 86 percent, 82 percent and 84 percent. New York State Vehicle & Traffic Law Section 375 12-(b)(1) states: “No person shall operate any motor vehicle upon any public highway, road or street, the front windshield of which is composed of, covered by or treated with any material which has a light transmittance of less than seventy percent unless such materials are limited to the uppermost six inches of the windshield.” To the extent that law is applicable to the vehicle headlight glare blocking attachment according to the invention, when the window blind is closed, the unblocked portion of the windshield is at least 82 percent, not counting the unblocked portion of the windshield to the left of the window blind. So the invention fully complies with this New York State law and, presumably, the corresponding laws of many other municipalities. For windshields of smaller width than 49 inches, the width of the window blind can be reduced to less than nine inches in order to comply with any applicable law.

However, some jurisdictions have laws which prohibit the use of the invention because it obstructs the driver's view through the windshield; for example, Section 375(30) of the New York State Vehicle and Traffic Law.

The commercial window blind is nine inches wide and had a height of 14 inches when fully open. In the invention as first reduced to practice only about nine inches of slats 22 height are used, the remaining slats 22 at the bottom resting together on the bottom rail 18 (FIG. 2), which is resting on the upper horizontal surface 32 of the vehicle's dash board 34. However, for drivers taller than the inventor (5′ 6″), the window blind can be mounted higher on the inside surface of a windshield with a longer height.

The above invention is disclosed and claimed in the parent application. What follows are new matter embodiments of the invention first disclosed and claimed in this continuation-in-part application as patentable improvements of the above invention.

### NEW MATTER EMBODIMENTS OF THE INVENTION

In the embodiment of the invention as disclosed in the parent application, upper horizontal portion 32 (FIG. 2) of dash panel 34 descends downwardly on its left side so the left end of bottom rail 18 of window blind 10 is supported only by the substantially 90 degree bend of steel incline wire 26b which is loosely connected to suction cup 28b. So bottom rail 18 is essentially fixed in a substantially horizontal position and the window blind 10 is substantially vertical and does not move with vehicle movement.

In all the new matter embodiments of the invention first disclosed in this application, the steel wire 26b remains bent substantially 90 degrees and extends toward the windshield 12 but is not connected to suction cup 28b. Instead steel wire 26b is loosely and detachably connected by matching male and female VELCRO strips to upper horizontal portion 32 of dash panel 34 between window blind 10 and windshield 12 and suction cup 28b is not used. Nor are steel wire 26a and suction cup 28a used. Also, each of the new matter embodiments of the invention can be an attachment to an existing vehicle, or built into a new vehicle as original equipment.

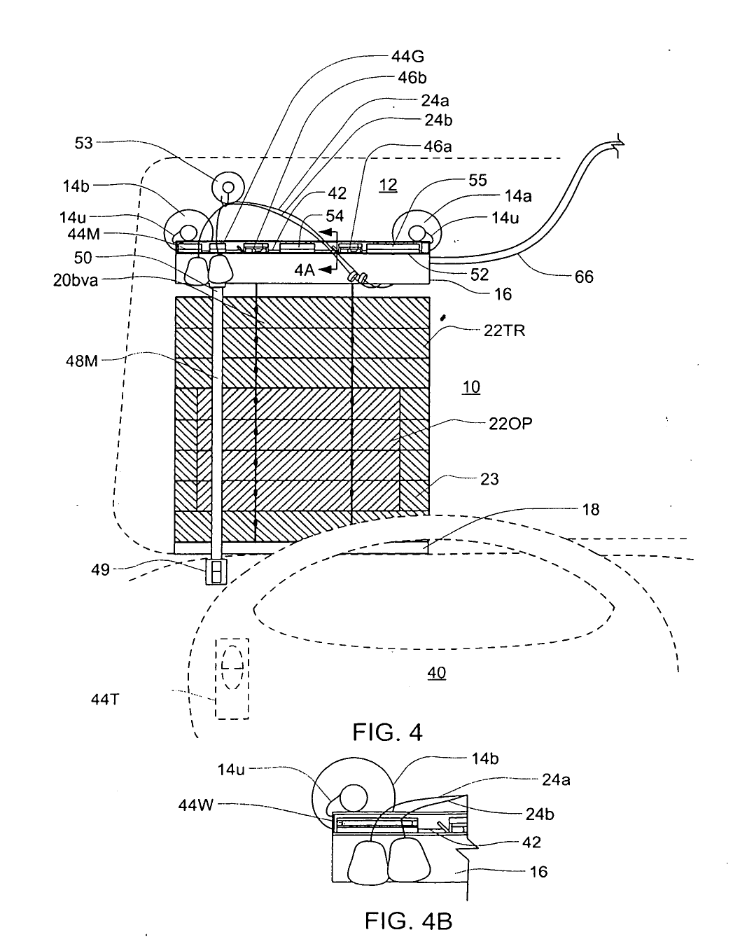

In an embodiment of the invention first disclosed in this application, the aluminum slats 22 (FIG. 2) are replaced by transparent plastic slats 22TR as shown in FIG. 4, and the slats 22OP in a central portion of the window blind 10 are painted opaque to block incoming headlight glare when closed. In this embodiment of the invention, when the slats 22 are closed, the remaining portion of window blind 10 comprising transparent plastic slats 22TR does not block the driver's view of the road. Thus the slats 22 and the bottom rail 18 of the window blind 10 need only be as wide as the width of the opaque slats 22OP, but with headrail 16 remaining the same length. So the amount of front windshield 10 that is blocked when slats 22OP are closed is substantially reduced.

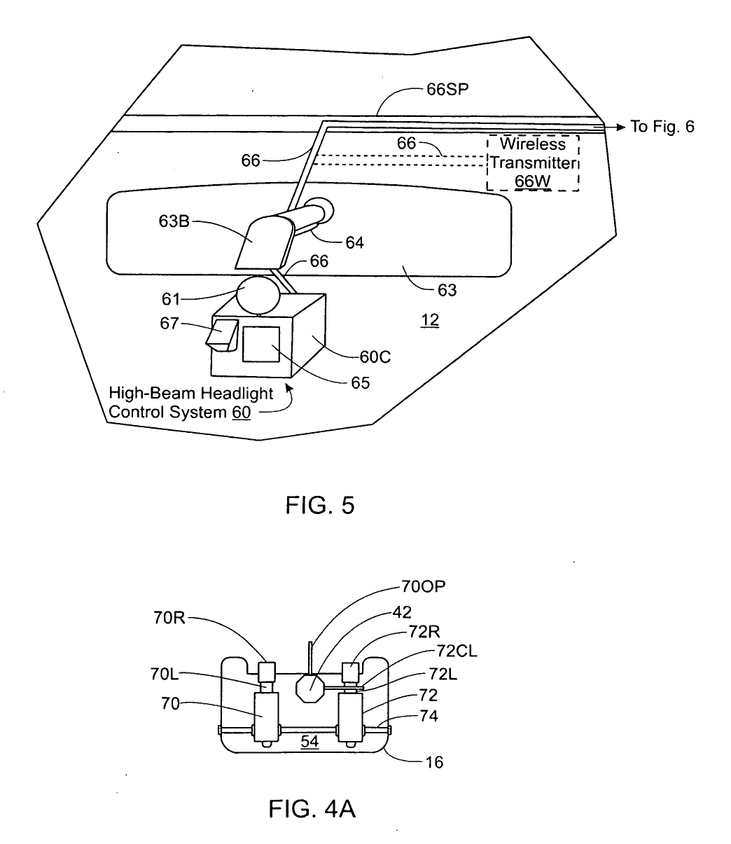

Moreover, as original equipment in new vehicles, railhead 16 (FIG. 2) can be mounted on the inside of the windshield with a button like a rearview mirror mounting button (see button 63B in FIG. 5); that is, without suction cups.

### DETAILED DESCRIPTION OF AUTOMATIC HEADLIGHT GLARE BLOCKING PREFERRED EMBODIMENT OF THE INVENTION

Of all the embodiments of the invention first disclosed in this application, this is the preferred embodiment.

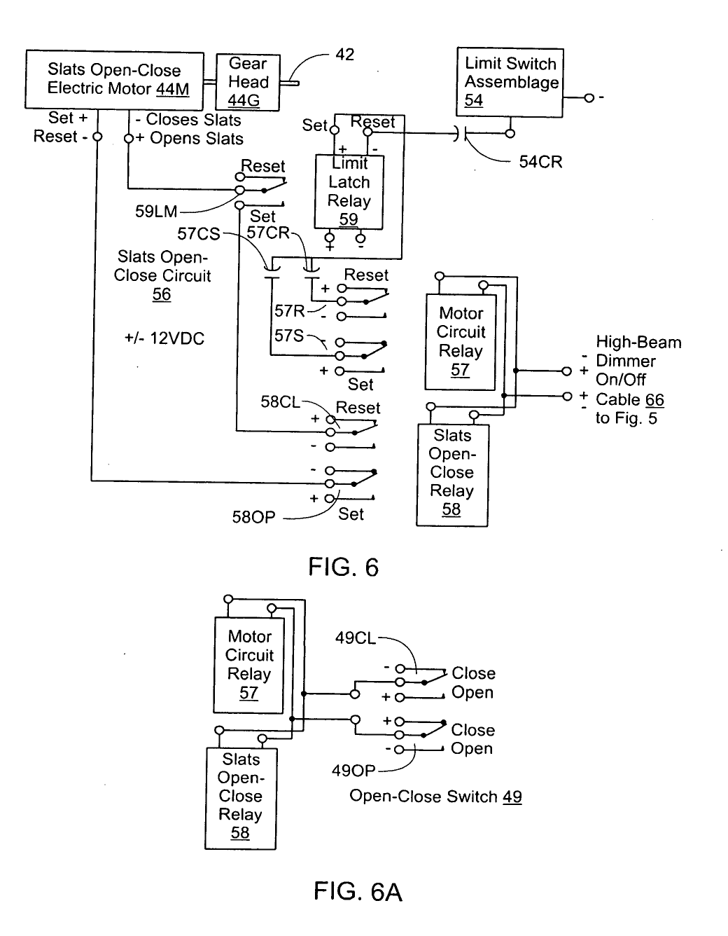

In this automatic headlight glare blocking system, high-beam headlight control system 60 (FIG. 5) is electrically connected by cable 66 to the input of slats open-close circuit 56 (FIG. 6) which is mainly on printed circuit board 55 (FIG. 4) mounted inside the right end of railhead 16 of window blind 10. Cable 66 (FIG. 5) passes through space 66SP between the upper edge of windshield 12 and the vehicle's fabric roof covering adjacent to the upper edge of windshield 12 and then descends and connects to slats open-close circuit 56 (FIG. 6) in railhead 16 (FIG. 4).

Cable 66 (FIG. 5) comprises insulated plus and minus 12 volt direct current wires to power slats open-close circuit 56 (FIG. 6) and slats open-close electric motor 44M (FIG. 4). Cable 66 also comprises a pair of insulated high-beam dimmer On/Off wires with a minus-plus 12 VDC signal representing dimmer On to close slats 22 and a plus-minus 12 VDC signal representing dimmer Off to open slats 22. Slats open-close circuit 56 operates electric motor 44M (FIG. 4) and gearhead 44G coupled to axle 42 to rotate ladder cord drums 46a and 46b to close and open slats 22.

Also mounted in railhead 16 between ladder cord drums 46a and 46b is limit switch assemblage 54 which controls the amount of rotation by electric motor 44M and gearhead 44G of axle 42 clockwise and counterclockwise about ninety degrees to close and open slats 22.

Axle 42 (FIG. 4) is normally in the slats open position. When high-beam headlight control system 60 (FIG. 5) detects headlight glare from an oncoming vehicle it sends a high-beam dimmer On signal to the slats open-close circuit 56 (FIG. 6) which operates electric motor 44M to turn axle 42 (FIG. 4) clockwise about ninety degrees to close slats 22. When high-beam headlight control system 60 (FIG. 5) detects the end of the headlight glare, it sends a high-beam dimmer Off signal via cable 66 to slats open-close circuit 56 (FIG. 6) which rotates electric motor 44M to turn axle 42 (FIGS. 4 and 4A) counterclockwise to reopen slats 22. Limit switch assemblage 54 limits each rotation of axle 42 to about ninety degrees.

A front elevational view of limit switch assemblage 54 taken from the center right of railhead 16 (FIG. 4) is shown in FIG. 4A. Limit switch assemblage 54 comprises mini snap-action limit switches 70 and 72, each with a roller lever to close the switch and stop electric motor 44M when the roller lever is depressed. Limit switch 70 comprises lever 70L with roller 70R at the lever's end which extends slightly beyond the body of the switch. Limit switch 72 comprises lever 72L with roller 72R at the lever's end which extends slightly beyond the body of the switch. Limit switch 70 is closed when stud 70OP radially extending vertically from axle 42 rotates counterclockwise about ninety degrees toward limit switch 70 and pushes roller 70R downward to temporarily close the switch to open slats 22 (FIG. 4) and stop electric motor 44M. Limit switch 72 (FIG. 4A) is closed when a stud 72CL then radially extending vertically from axle 42 rotates clockwise about ninety degrees toward limit switch 72 and pushes roller 72R downward to temporarily close the switch to close slats 22 and stop electric motor 44M.

Initially, when stud 72CL is in the vertical position and the slats are open, stud 70OP radially extends horizontally from axle 42 ninety degrees from stud 72CL and just below roller 70R. When stud 72CL rotates ninety degrees clockwise toward and closes limit switch 72 to close slats 22, stud 70OP slips over roller 70R and rotates to the vertical position. When stud 72OP rotates ninety degrees counterclockwise toward and closes limit switch 70 to open the slats, stud 72CL slips over roller 72R and rotates to the vertical position. Two bolts and associated spacers 74 through two horizontally displaced mounting holes through the lower bodies of limit switches 70 and 72 fixedly mount the limit switches to railhead 16.

When either limit switch 70 or 72 is temporarily closed, limit switch assemblage 54 (FIG. 6) sends a minus 12 direct current voltage signal to capacitor 54CR which thus sends a negative pulse to the reset terminal of limit latch relay 59 to reset the relay. When limit latch relay 59 is reset its contacts 59LM open to open the 12 volt direct current circuit to electric motor 44M to stop electric motor 44M with the slats 22 (FIG. 4) in either the open or close position depending on which direction slats open-close electric motor 44M rotates axle 42 about ninety degrees.

When high-beam headlight control system 60 (FIG. 5) detects headlight glare from an oncoming vehicle it sends a high-beam dimmer On minus-plus 12 VDC signal via cable 66 to the slats open-close circuit 56 (FIG. 6) to close slats 22. When high-beam headlight control system 60 (FIG. 5) detects the end of headlight glare from an oncoming vehicle it sends a high-beam dimmer Off plus-minus 12 VDC signal via cable 66 to slats open-close circuit 56 (FIG. 6) to open the slats.

High-beam dimmer On/Off wires from high-beam headlight control system 60 (FIG. 5) via cable 66 are connected respectively to the relay control terminals of motor circuit relay 57 (FIG. 6) and slats open-close relay 58 to set the relays with a minus-plus 12 volts direct current signal to close the slats, and later reset the relays with a plus-minus 12 volts direct current signal to open the slats. The contacts of relays 57, 58 and 59 are shown in the normal slats open or reset position.

The purpose of motor circuit relay 57 is to set limit latch relay 59 and thus the movable arm of contacts 59LM to the set or close position to close the 12 volts motor circuit to slats open-close electric motor 44M whenever the high-beam dimmer On and Off signals switch polarities so the electric motor 44M operates clockwise or counterclockwise to close and open the slats. When the high-beam dimmer On signal is sent to the control terminals of motor circuit relay 57 it sets the relay to move the movable arms of contacts 57R and 57S from the upper or reset position to the lower or set position to set limit latch relay 59 to close its contacts 59LM to close the electric motor 44M circuit. The moving arm of contacts 57S sends a plus 12 VDC signal to capacitor 57CS which is coupled to the set terminal of limit latch relay 59 so a positive pulse sets limit latch relay 59 to the set position closing its 59LM contacts. When the high-beam dimmer Off signal is sent to the control terminals of motor circuit relay 57 it resets the relay to move the movable arms of contacts 57R and 57S from the lower or set position to the reset position to close the electric motor 44M circuit. The moving arm of contacts 57R sends a plus 12 VDC to capacitor 57CR which is coupled to the set terminal of limit latch relay 59 so a positive pulse sets limit latch relay 59 to the set position closing its 59LM contacts. Minus 12 VDC signals sent to capacitors 57CS and 57CR also send negative pulses to the set terminal of limit latch relay 59, which have no effect on limit latch relay 59 whose set terminal is only responsive to a plus voltage. The moving arms of the contacts of motor circuit relay 57 are adjusted so that they close at slightly different times in order to avoid simultaneously sending plus and minus signals to the capacitors 57CS and 57CR.

Simultaneously with the setting of motor circuit relay 57, the high-beam On signal also sets slats open-close relay 58 so the movable arms of its contacts 58CL and 58OP move from the reset to the set position. Contacts 58CL connect a minus 12 VDC signal via the closed contacts 59LM to the right terminal of the slats open-close electric motor 44M. The left terminal of electric motor 44M is directly connected to the set or plus 12 VDC position of contacts 58OP to rotate electric motor 44M and axle 42 (FIG. 4) clockwise (FIG. 4A) and thus rotate ladder cord drums 46a and 46b (FIG. 4) clockwise about ninety degrees to close slats 22.

As axle 42 (FIG. 4A) rotates clockwise to close slats 22, stud 72CL rotates toward mini snap-action switch 72 to close switch 72 so limit switch assemblage 54 (FIG. 6) sends a minus 12 VDC signal to capacitor 54CR and thus a negative pulse to the reset terminal of limit latch relay 59 to reset contacts 59LM to the reset position to open the motor circuit to slats open-close electric motor 44M. That stops electric motor 44M after axle 42 has rotated about ninety degrees to close the slats and block headlight glare from an oncoming vehicle.

When high-beam headlight control system 60 (FIG. 5) detects that the glare has ended, it sends a high-beam dimmer Off signal via cable 66 (FIG. 6) to reset motor circuit relay 57 and slats open-close relay 58, moving their respective movable arms to the reset position. When the moving arms of relay 57 sequentially close, a plus 12VDC signal is sent to capacitor 57CR which sends a positive pulse to the set terminal of limit latch relay 59 closing contacts 59LM to complete the motor circuit to open-close electric motor 44M to open the slats.

The high-beam dimmer Off signal switches slats open-close relay 58 to the reset position so contacts 58CL and 58OP respectively connect a plus 12 VDC signal to the right terminal of slat open-close electric motor 44M and a minus 12 VDC signal to the left terminal of electric motor 44M to activate electric motor 44M to turn axle 42 counterclockwise about ninety degrees and limit switch assemblage 54 sends a negative 12 VDC signal to capacitor 54CR and thus a negative pulse to the reset terminal of limit latch relay 59 to open its contacts 59LM after axle 42 turns counterclockwise about ninety degrees to open the slats so the driver can readily see the oncoming lane then free of headlight glare.

The high-beam headlight control system 60 is shown in FIG. 5 with the view through a vehicle windshield 12 of the case 60C that encloses the mechanics, optics and associated electronics of control system 60. Case 60C is mounted on the inside surface of windshield 12 by a strong suction cup 61 just below the rearview mirror's button 63B attached to the inside of the windshield 12 which supports the rearview mirror casing 63. Cable 64 connects the control system 60 to the vehicle's 12 volt direct current supply in the rearview mirror casing 63 directly or by plugging into a light bulb socket in the rearview mirror casing 63 or into a light bulb socket in the vehicle's dome light. Lens 65 is positioned to view the headlamps of oncoming vehicles and the tail lamps of leading vehicles and to communicate and focus these signals on a sensor of the control system 60. Lens 67 senses ambient light as described below.

The high-beam headlight control system 60 is disclosed in detail in U.S. Pat. No. 5,537,003 (003 patent) for a Control System for Automotive Vehicle Headlamps and Other Vehicle Equipment issued Jul. 16, 1996, to Gentex Corporation of Zeeland, Michigan. In the 003 patent its FIG. 1 corresponds to FIG. 5 in this specification. The 003 description is summarized in its Abstract: “A control system is provided for controlling the energization of the headlamps on a first automotive vehicle, the headlamps being electrically energizable and each having a high beam state and a low beam state. The system includes means for collecting light emanating from a second vehicle and means for collecting ambient light. Sensing means is provided which is effective to selectively sense the intensity of the collected light emanating from the second vehicle and the collected ambient light. In addition, the system includes means controlling the state of the beams of the headlamps as a function of the sensed intensity of the beam of light emanating from said second vehicle, and means controlling the electrical energization of the headlamps as a function of the sensed ambient light.”

The 003 specification also states: “The light guide and entrance lens assembly 3 (67 in FIG. 5) for the headlamp on/off function extends forward from the case 100 (60C in FIG. 5) so that light from a wide area of the sky falls on its entrance lens through the windshield 102 (12 in FIG. 5) and a portion of this light is directed to and sampled by the sensing unit in case 100 (60C in FIG. 5). Likewise the lens 2 (65 in FIG. 5) may be positioned with reasonable but not extraordinary precision to view the headlamps of oncoming vehicles and the tail lamps of leading vehicles and to communicate and focus these signals on the unit's sensor.”

The 003 patent further states: “The cable 105 (66 in FIG. 5) also connects to a relay or relays which energize and de-energize the headlamps, running lamps, and tail lamps and to a relay which switches between the vehicles high beam and low beam configurations.” The latter relay is presumably a commercial auto headlight dim relay. In this specification the 003 patent circuitry is modified if required so the high beam dimming signal in cable 66 is minus-plus 12 VDC and the low beam undimming signal in cable 66 is plus-minus 12 VDC on a single pair of wires.

The 003 patent also states: “FIG. 7 is a block diagram of the micro controller based control circuit with more detail given for the electronic drive circuit for the motor. . . . The power supply module 700 supplies a 12 V signal to . . . the sensor for its integrated amplifier and to the light sensor interface module. . . . The circuit ground connection GND connects to the automotive ground. The headlamp dimmer and the headlamp on/off control interface includes options to enable or disable the automatic functions. . . . The control interface 702 sends signals . . . to turn the vehicle headlamps, tail lamps, and running lamps on and off as required. This automatic command is paralleled by the manual switch which the driver can use to override the headlamp on/off control at any time.” In this specification, the headlamp dimmer option can be used to disable (override) the headlight dimmer function to open closed slats, for example for left turns.

FIG. 7a of the 003 patent discloses a block diagram with a control interface 702 generating a “HIGH BEAM ON/OFF” signal, shown as the input to the slats open-close circuit 56 of FIG. 6.

In the high-beam headlight control system 60 of this specification only the circuitry, optics and mechanics of the 003 patent for the headlamp dimmer system and not the headlamp on/off system need be used. However, optionally, the headlamp on/off system and other features of the 003 patent system can be used.

Slats open-close electric motor 44M (FIG. 6) can be a reversible 12 VDC micro motor Part Number 16G88-211E supplied by Portescap Company of Danaher Motion Corporation, West Chester, Pa., and gearhead 44G can be a reduction gearhead with spur gears Part Number B16 0 1215 supplied by the same company. A special adapter on the motor has a threaded boss and the gearhead threads onto the adapter.

Limit switches 70 and 72 (FIG. 4A) each can be the SPDT-Mini Snap-Action Switch W/Roller Lever, CAT# SMS-219, supplied by All-Electronics Corporation of Van Nuys, Calif.

Motor circuit relay 57 (FIG. 6) and slats open-close relay 58 each can be a mini DPDT Power PC8 Relay RT2 bistable, Part No. 4-1393243-6, supplied by Tyco Electronics, Ltd. of Berwyn, Pa.

Limit latch relay 59 can be a 12VDC RBR1224 electronic toggle/ratchet relay supplied by Altronix Corp of Brooklyn, N.Y. This relay is too large to be mounted on the printed circuit board 55 (FIG. 4) inside railhead 16 so must be mounted on the outside of railhead 16. In a preferred embodiment this relay is miniaturized to mount inside railhead 16.

Capacitors 57CS, 57CR and 54CR (FIG. 6) are each an electrolytic capacitor, 20 microfarads, 50 VDC, axial leaded, part number TVA1305.5-E3, supplied by Allied Electronics of Fort Worth, Tex.

### OTHER EMBODIMENTS OF THE INVENTION

In another embodiment of the invention as first disclosed in this application, slats open-close electric motor 44M (FIG. 4) plus gearhead 44G, which replace gear box 44 (FIG. 1) and rod 48, rotate the turn axle 42 (FIG. 4) to close and open slats 22. The electric motor 44M is a 12 volt direct current reversing micro motor as described above. Rod 48 (FIG. 1) is replaced by a six-wire electric cord 48M (FIG. 4) which terminates in a double-pole-double-throw rocker open-close switch 49 that, via slats open-close circuit 56 (FIG. 6), causes electric motor 44M (FIG. 4) to close and open slats 22 by feeding to the respective right and left terminals of electric motor 44M minus-plus 12 VDC to close slats 22 or plus-minus 12 VDC to open slats 22. Electric motor 44M rotates turn axle 42 clockwise about 90 degrees to close slats 22 and counterclockwise about 90 degrees to open slats 22.

Railhead 16 of window blind 10 (FIG. 4) is mounted on the inside surface of windshield 12 so that rocker open-close switch 49 hangs via electric cord 48M adjacent the left side of the steering wheel 40. To close or open slats 22, the close position or the open position of rocker open-close switch 49 is temporarily operated by the thumb and one finger of the drivers' side hand while remaining fingers grasp the steering wheel 40. Alternatively, rocker open-close switch 49 can be VELCRO mounted on the vehicle's steering column above the turn signal rod or on the vehicle's dashboard.

Open-close switch 49 closes slats 22 when headlight glare is oncoming and opens slats 22 to fully unblock the windshield 12 when no headlight glare is oncoming by respectively temporarily pushing the rocker of the open-close switch 49 to the close position or to the opposite open position. In this embodiment of the invention the slats 22 are closed and opened much faster than with rod 48, as are all new matter embodiments of the invention using electric motor 44M that are first disclosed in this application.

More particularly, the high-beam dimmer On/Off signals at the input of slats open-close circuit 56 (FIG. 6) via cable 66 from high-beam headlight control system 60 (FIG. 5) are replaced by corresponding signals from double-pole-double-throw rocker open-close switch 49 (FIG. 6A). The high-beam On signal (FIG. 6) is minus-plus 12VDC to close the slats and the high-beam Off signal is plus-minus 12VDC to open the slats. The high-beam dimmer On (minus-plus) signal is connected respectively to the two input terminals of motor circuit relay 57 and to the paralleled two input terminals of slats open-close relay 58 to set the relays and close the slats. The high-beam Off (plus-minus) signal is also respectively connected to the two input terminals of motor circuit relay 57 and to the paralleled two input terminals of slats open-close relay 58 to reset the relays and open the slats.

When double-pole-double-throw rocker open-close switch 49 (FIG. 6A) replaces the high-beam On/Off signals at the input of slats open-close circuit 56 (FIG. 6), the two movable arms of contacts 49CL and 49OP (FIG. 6A) via electric cord 48M (FIG. 4) are respectively connected to the two input terminals of motor circuit relay 57 (FIG. 6A) and the paralleled two input terminals of slats open-close relay 58. The two fixed close contacts of open-close switch 49 are connected via electric cord 48M (FIG. 4) respectively to minus and plus 12 VDC in railhead 16. The two fixed open contacts of open-close switch 49 are connected via electric cord 48M respectively to plus and minus 12 VDC in railhead 16. So when the rocker of open-close switch 49 (FIG. 6A) is switched to the close position a minus-plus 12 VDC signal is fed to motor circuit relay 57 and to slats open-close relay 58 to set those relays and close the slats. When the rocker of open-close switch 49 is switched to the open position, a plus-minus 12 VDC signal is fed to motor circuit relay 57 and slats open-close relay 58 to reset those relays and open the slats.

Thus, the slats are rapidly closed only when headlight glare is oncoming to block the glare and rapidly opened to fully unblock the vehicle's windshield when there is no oncoming headlight glare by respectively pushing the rocker of the open-close switch 49 to the close position or to the open position. After the slats have been moved to the close or open position, the rocker of open-close switch 49 can be manually set in the center or off position to terminate the relay operating signals.

Open-close switch 49 can be a NKK rocker switch Part No. M2028TJW01-FA-1A supplied by NKK Switches of America, Inc. of Scottsdale, Ariz. This switch has the following characteristics: double-pole-double-throw with a center off position, on when the rocker is pushed to the close position to close the slats and on when the rocker is pushed to the open position to open the slats, with the center position of the rocker switch in the off mode; snap-in mounting in a suitable metal container; silver contacts; solder lugs; and 0.450″ wide rocker.

In another embodiment of the invention as first disclosed in this application, to open closed slats 22 (FIG. 4) as needed, especially for left turns, high-beam headlight control system 60 (FIG. 5) is modified to send temporary rather than continuous On/Off signals to the input of slats open-close circuit 56 (FIG. 6) to close and open slats 22. Rocker open-close switch 49 (FIG. 6A) is connected to the input of slats open-close circuit 56 (FIG. 6) in parallel with the On/Off signal wires of cable 66 (FIG. 6) to open slats 22 after the On signal from high-beam headlight control system 60 closing the slats has terminated. Rocker open-close switch 49 is positioned adjacent the driver's side of the steering wheel 40 (FIG. 4) by the electric cord 48M or VELCRO connected to the vehicle's steering column or to the dashboard of the vehicle.

In a further embodiment of the invention as first disclosed in this application, the gear box 44 (FIG. 1) and rod 48 are replaced by a commercially available wireless-operated electric slat tilt motor device 44W (FIG. 4B) which rotates turn axle 42 to close and open slats 22. The electric slat tilt motor device 44W can be powered by a 12 VDC connector to the vehicle's cigarette lighter socket or by encased serial batteries comprising 12 VDC attached to the railhead 16. The electric slat tilt motor device 44W is controlled by a battery-powered wireless transmitter 44T (FIG. 4) VELCRO mounted on the left side of the steering wheel 40 adjacent the driver's left hand. The wireless transmitter 44T comprises a thumb-operated switch with a close slats position and a separate open slats position to close and open slats 22. Somfy Systems Inc., North America Headquarters, Dayton, N.J., USA, manufactures such a wireless-operated electric slat tilt motor device (TILT WIREFREE RTS motor for horizontal blinds, Part No. 100678, headrail adapter Part No. 901528, shaft adapter Part No. 9014535) and associated wireless transmitter (TELIS 1 RTS radio transmitter, Part No. 6301014) to close and open slats 22. This embodiment of the invention requires in place of the smaller gear box 44 (FIG. 1) and its railhead 16 a larger headrail 16 to accommodate the wireless-operated electric slat tilt motor and associated headrail adapter shown as device 44W in FIG. 6A as sold by Somfy Systems Inc.

In a still further embodiment of the invention first disclosed in this application, the commercially available wireless-operated electric slat tilt motor device 44W (FIG. 4B) just described is directly and automatically wireless operated by a wireless transmitter 66W (FIG. 5) installed in the high-beam headlight control system 60 described above. When high-beam headlight control system 60 senses oncoming headlight glare it wirelessly operates the electric slat tilt motor device 44W (FIG. 4B) to close the slats to block the oncoming headlight glare and reopen the slats when the glare ends. The high-beam headlight control system 60 is wirelessly connected by wireless transmitter 66W to wireless-operated electric slat tilt motor device 44W in railhead 16 by duplicate circuitry of the wireless transmitter 44T (FIG. 4) to transmit corresponding close and open signals in place of the minus-plus and plus-minus signals normally transmitted by control system 60 to slats open-close circuit 56 via cable 66. For example, the minus-plus high beam dimming signal and the plus-minus low beam nondimming signal can operate a transmitter control relay like a commercial auto headlight dim relay in the control system 60 to cause the wireless transmitter 66W to transmit slats close and slats open signals to the electric slat tilt motor device 44W in railhead 16 to close and open the slats. That is, the high beam dim contacts of the transmitter control relay can replace the close position contacts of wireless transmitter 66W and the low beam contacts of the transmitter control relay can replace the open position contacts of wireless transmitter 66W.

When slats 22 are closed but must be open, for example for left turns, the wireless transmitter 44T on the left side of the steering wheel 40 (FIG. 4) is operated to open slats 22 if the slats are temporarily closed by high-beam headlight control system 60 (FIG. 5) using the wireless transmitter 66W as just described.

In summary, the default position of slats 22 (FIG. 4) is the open position to minimize blocking of the driver's vision by window blind 10. For left turns, when slats 22 are closed and must be open, or to otherwise open slats 22, rocker open-close switch 49 is operated to open the slats 22 when the slats are temporarily closed by rocker open-close switch 49 by moving the rocker to the open position. Alternatively, wireless transmitter 44T can open otherwise closed slats when it directly wirelessly operates electric slat tilt motor device 44W, or when wireless transmitter 66W in high-beam headlight control system 60 closes the slats, by pushing the open slats position on wireless transmitter 44T. In this way the circuitry closing slats 22 can be overridden and slats 22 opened by rocket open-close switch 49 or wireless transmitter 44T.

While the invention has been described for use in countries where the convention is to drive on the right side of a road, in those countries with a convention of driving on the left side of the road, as in England, the window blind 10 is mounted on the right side of the windshield above the right side of the steering wheel and operates in a substantially mirror image to that of right side road driving.

Thus, in accordance with the apparatus and method of each of the embodiments of the invention first disclosed in this application, improved glare blocking vehicle systems as attachments, or built into new vehicles as original equipment without suction cup mounting means, have been provided accomplishing all of the objects in place of the smaller gear box 44 (FIG. 1) and its railhead 16 and having the features and advantages specified in this specification, and as claimed in the following claims which are clearly patentably distinct from the allowed claims in the parent application.

What is claimed is:

1. A method of reducing glare from oncoming vehicle headlights, said method comprising:
Providing glare reducing means for a vehicle front windshield glass, the vehicle having a driver's side and a passenger side, said glare reducing means connected to said front windshield glass and adapted to substantially transmit light through said vehicle front windshield glass and alternatively to substantially reduce transmitted light through said vehicle front windshield glass, said glare reducing means having a width less than 30 percent of the average horizontal width of the vehicle's front windshield glass and having part of an inside edge substantially vertically aligned with substantially the horizontal center of said steering wheel with the area of said front windshield glass above substantially half of said steering wheel and the passenger's side being unblocked so that the driver can always see the driver's side of the road;
Providing automatic optical detecting means on the vehicle for automatically optically detecting when an oncoming vehicle with lit headlights is approaching the driver and automatically optically detecting when an oncoming vehicle with lit headlights is not approaching the driver;
Driving the vehicle on a surface that can have oncoming traffic;
Automatically optically detecting when at least one oncoming vehicle with lit headlights is approaching the driver;
Automatically operating said glare reducing means to substantially reduce transmitted light through said vehicle front windshield glass in response to automatically optically detecting when at least one oncoming vehicle with lit headlights is approaching the driver to reduce headlight glare through said glare reducing means including the area between said inside edge and the remaining area of said glare reducing means when there is at least one oncoming vehicle with lit headlights approaching;
Automatically optically detecting when an oncoming vehicle with lit headlights is not approaching the driver;
Automatically operating said glare reducing means to substantially transmit light through said vehicle front windshield glass in response to automatically optically detecting when an oncoming vehicle with lit headlights is not approaching the driver to allow a driver to see through said glare reducing means when there is no oncoming traffic with lit headlights approaching; and
Repeating the automatic substantially light reducing and automatic substantially light transmitting steps by said glare reducing means while driving to accommodate varying oncoming traffic.

2. A glare reducing system for a vehicle having a driver's side and a passenger's side comprising:
a front windshield glass and steering wheel on said vehicle;
glare reducing means comprising said front windshield glass adapted to substantially transmit light and alternatively to substantially reduce transmitted light through said front windshield glass, said glare reducing means having a width less than 30 percent of the average horizontal width of said front windshield glass and having part of an inside edge substantially vertically aligned with substantially the horizontal center of said steering wheel with the area of said front windshield glass above substantially half of said steering wheel and the passenger's side being unblocked so that the driver can always see the driver's side of the road;
automatic optical detecting means on said vehicle for automatically detecting when there is an oncoming vehicle with lit headlights and when there is no oncoming vehicle with lit headlights;
whereby for nighttime driving said automatic optical detecting means operates said glare reducing means to substantially transmit light through said vehicle front windshield glass when there is no oncoming vehicle with lit headlights to allow a driver to see through said glare reducing means; and
whereby for nighttime driving said automatic detecting means operates said glare reducing means to substantially reduce light through said vehicle front windshield glass including the area between said inside edge and the remaining area of said glare reducing means when there is an oncoming vehicle with lit headlights to reduce glare.

3. A glare reducing system for a vehicle having a driver's side and a passenger's side comprising:
a front windshield glass and a steering wheel on the vehicle;
glare reducing means on the vehicle adapted to substantially transmit light through said vehicle front windshield glass and alternatively to substantially reduce transmitted light through said vehicle front windshield glass, said glare reducing means comprising said front windshield glass and having a width less than 30 percent of the average horizontal width of said front windshield glass and having part of an inside edge substantially vertically aligned with substantially the horizontal center of said steering wheel with the area of said front windshield glass above substantially half of said steering wheel and the passenger's side being unblocked so that the driver can always see the driver's side of the road;
whereby for nighttime driving said glare reducing means operates to substantially transmit light through said vehicle front windshield glass when there is no oncoming vehicle with lit headlights to allow a driver to see through said glare reducing means, and to substantially reduce transmitted light through said vehicle front windshield glass including the area between said inside edge and the remaining area of said glare reducing means when there is an oncoming vehicle with lit headlights to reduce glare.

4. A glare reducing system according to claim 3 wherein said glare reducing means is connected to said front window glass and further comprising a manually operated switch on the steering wheel of the vehicle adapted to remotely operate said glare reducing means to substantially transmit light through said vehicle front windshield glass and alternatively to substantially reduce transmitted light through said vehicle front windshield glass.

5. A method of reducing glare from oncoming vehicle headlights, said vehicle having a driver's side, a passenger side, a front windshield glass and a steering wheel, said method comprising:
Glare reducing means adapted to substantially transmit light through said vehicle front windshield glass and alternatively to substantially reduce light through said vehicle front windshield glass, said glare reducing means having a width less than 30 percent of the average horizontal width of the vehicle's front windshield glass and having part of an inside edge substantially vertically aligned with substantially the horizontal center of said steering wheel with the area of said front windshield glass above substantially half of said steering wheel and the passenger's side being unblocked so that the driver can always see the driver's side of the road;
Securing said glare reducing means with mounting means directly on the vehicle's front windshield glass on the driver's side such that the passenger side is uncovered;
Driving said vehicle on a surface that can have oncoming traffic;
Remotely operating said glare reducing means while driving to substantially transmit light to allow a driver to see through said glare reducing means when there is no oncoming traffic with lit headlights approaching;
Remotely operating said glare reducing means to substantially reduce light while driving to reduce glare when there is at least one oncoming vehicle with lit headlights approaching the driver; and
Repeating the substantially light transmitting and substantially light reducing steps by said glare reducing means while driving to accommodate varying oncoming traffic.

6. A method of reducing glare from oncoming vehicle headlights according to claim 5 wherein said glare reducing means is remotely operated by a wireless switch attached to the surface of the vehicle's steering wheel.

7. A method of reducing glare from oncoming vehicle headlights according to claim 6 wherein said wireless switch attached to the surface of the vehicle's steering wheel is operable by the thumb of the driver's hand.

8. A glare reducing system for a vehicle according to claim 3 wherein said glare reducing means is connected to said front windshield glass and further comprising a wireless switch detachably attached to the surface of the vehicle's steering wheel to remotely operate said glare reducing means to substantially transmit light through said vehicle front windshield glass when there is no oncoming vehicle with lit headlights to allow a driver to see through said glare reducing means and to substantially reduce transmitted light through said vehicle front windshield glass when there is an oncoming vehicle with lit headlights to reduce glare.

9. A glare reducing system for a vehicle according to claim 3 further comprising automatic optical detecting means on said vehicle to operate said glare reducing means to substantially transmit light when there is no oncoming vehicle with lit headlights to allow a driver to see through said glare reducing means, and to substantially reduce transmitted light when there is an oncoming vehicle with lit headlights to reduce glare.

10. A glare reducing system for a vehicle according to claim 3 further comprising a manually operated switch to remotely operate said glare reducing means to substantially transmit light through said vehicle front windshield glass to allow a driver to see through said glare reducing means even if there is an oncoming vehicle with glaring headlights.

11. A glare reducing system for a vehicle according to claim 3 further comprising a manually operated switch to remotely operate said glare reducing means to substantially transmit light through said vehicle front windshield glass to allow a driver to see through said glare reducing means when the vehicle is making a left turn even if there is an oncoming vehicle with glaring headlights.

12. A glare reducing system according to claim 3 wherein said glare reducing means comprises a slatted blind having a headrail and a bottom rail, flexible ladder means connected between said headrail and said bottom rail and a plurality of slats supported by said flexible ladder means; and electric motor rotation means mounted on said slatted blind for rotating said slats between open and closed positions.

13. A glare reducing system according to claim 3 further comprising automatic detecting means for automatically detecting when there is an oncoming vehicle with glaring headlights and when there is no oncoming vehicle with glaring headlights; mounting means connected to said automatic detecting means for mounting said automatic detecting means on the inside of said front windshield; whereby for nighttime driving said automatic detecting means operates said electric motor rotation means to open said slats when there is no oncoming vehicle with glaring headlights to allow a driver to see through said slatted blind and close said slats when there is an oncoming vehicle with glaring headlights to reduce the glare.

14. A glare reducing system according to claim 13 wherein said vehicle also has a rearview mirror mounted on the vehicle's windshield and said automatic detecting means is mounted adjacent said rearview mirror.

15. A glare reducing means according to claim 13 wherein said vehicle also has a rearview mirror mounted on the vehicle's windshield and said automatic detecting means is mounted on the windshield just below said rearview mirror.

16. A glare reducing system according to claim 12 wherein said electric motor rotation means comprises a wireless receiver to rotate said slats, and a wireless transmitter to operate said wireless receiver to open and close said slats.

17. A glare reducing means for a vehicle according to claim 16 wherein said wireless transmitter is attached to the vehicle's steering wheel and can be operated with a finger of the driver's hand while remaining fingers grasp the steering wheel.

18. A glare reducing means for a vehicle according to claim 12 further comprising an automatic detecting means connected to said electric motor rotation means to open said slats to allow a driver to see through said slats when there is no oncoming traffic with lit headlights approaching and to close said slats to prevent a driver from seeing through said slats when there is at least one oncoming vehicle with lit headlights approaching.

19. A glare reducing system for a vehicle according to claim 3 further comprising a manually operated wireless switch attached to said steering wheel to remotely operate said glare reducing means to substantially transmit light through said vehicle front windshield glass to allow a driver to see through said glare reducing means even if there is an oncoming vehicle with glaring headlights.

20. A glare reducing system for a vehicle according to claim 3 further comprising a manually operated wireless switch attached to said steering wheel to remotely operate said glare reducing means to substantially transmit light through said vehicle front windshield glass to allow a driver to see through said glare reducing means when making a left turn even if there is an oncoming vehicle with glaring headlights.
